(19) United States
(12) Patent Application Publication
(10) Pub. No.: US 2009/0033469 A1
(43) Pub. Date: Feb. 5, 2009

(54) Remote Detector And Method And Use Of A Remote Detector

(75) Inventor: Heikki Seppä, Helsinki (FI)

Correspondence Address: BIRCH STEWART KOLASCH & BIRCH, PO BOX 747, FALLS CHURCH, VA, 22040-0747, US

(73) Assignee: Valtion Teknillinen Tutkimuskeskus, Espoo (FI)

(21) Appl. No.: 11/920,242

(22) PCT Filed: May 5, 2006
(86) PCT No.: PCT/FI2006/000147

§ 371 Date: Mar. 12, 2008

(30) Foreign Application Priority Data
May 11, 2005 (FI) 20050501

(51) Int. Cl. H04Q 5/22

(52) U.S. Cl. 340/10.3

(57) ABSTRACT

The invention relates to a remote detector or sensor system. The system comprise a reading device (5), which is able to transmit and receive information wirelessly by means of electromagnetic radiation, and at least one remote detector or sensor (1, 32), which is able to communicate wirelessly with the reading device (5). According to the invention, the remote detector or sensor (1, 32) is connected permanently to an energy-consumption measuring or an energy consuming device and is arranged to transmit energy information wirelessly to a reading device (4).

The present invention relates to an RFID system, according to the preamble of claim 1.

The invention also relates to an RFID method and the use of an RFID transponder.

The invention is used for determining power consumption device or household-specifically and for forwarding the information, for example, for monitoring or invoicing.

At present, kilowatt-hour meters are read, either by the customer or by the power company, at intervals of about one year. The use of electricity could be made more efficient, if readings could be stored at an hourly level and the data transmitted to the power company several times a year. The use of pricing to reduce electricity-consumption peaks would cut both network and investment costs. In Sweden, the remote reading of kWh meters will soon become statutory. Finland and Norway will most probably follow Sweden's example. Hour-based reading will benefit both the customer and the power company. The power company will be able to use pricing to even out power peaks and thus to reduce network and power plant capacity. Consumers will be able to influence their costs through their behaviour.

Though power companies are interested in remote reading, this will mean replacing nearly all kWh meters with new meters, which will then have to be connected to remote reading through the telephone or electricity network. This would lead to enormous costs for the power company and finally these costs would be passed on to the consumer. As kWh meters are renewed only very slowly, the transition cannot be implemented only with the help of new meters. Attempts have been made to implement remote reading through co-operation between power and telecommunications companies. Using the prior art, however, this would force power companies to change all of their kilowatt-hour meters. At present price levels, the cost, including that of installation, is well over ε 100/meter, making the overall cost enormous.

The development of electronic wattmeters has created an interest in integrating the measurement of power and energy in domestic appliances. Technically, this has been possible for a long time, but the problem has been the interface. In addition to power measurement, a display and keypad would have to be connected to a domestic appliance. This is because an energy reading by itself is insufficient for the consumer to monitor the power consumption of a domestic appliance.

The invention is intended to eliminate the defects of the prior art disclosed above and for this purpose create an entirely new type of system, method, and use for making a power measurement.

The invention is based on using an RFID circuit, which is electrically connected to a device consuming power, or to an energy meter, as the element transmitting power or energy information. Power or energy information is transmitted wirelessly from the RFID circuit to an RFID reading device, which is, in turn, integrated in a mobile station, such as a GSM mobile telephone. In this application, the term RFID transponder refers to both a conventional remote transponder and to a remote sensor.

More specifically, the remote-detector system according to the invention is characterized by what is stated in the characterizing portion of claim 1.

The method according to the invention is, in turn, characterized by what is stated in the characterizing portion of claim 5.

The use according to the invention is, in turn, characterized by what is stated in the characterizing portion of claim 9.

Considerable advantages are gained with the aid of the invention.

With the aid of embodiments of the invention, an effective interface is obtained for power information measurement and transmission, at an economical cost. With the aid of embodiments of the invention, consumption and its time distribution can be monitored more effectively and, with the aid of the invention, the consumer also has an opportunity to obtain real-time information on their energy consumption and its time distribution. This information can be utilized for regulating consumption, for example, using various time tariffs, which will guide the consumer more precisely than before to behave in a way that will eliminate energy-consumption peaks. This means that embodiments of the invention can be used to assist in reducing total energy consumption, thus bringing positive environmental impacts. On the other hand, with the aid of the invention, energy-producing companies can achieve significant savings in investments in both transmission networks and in production plants, as their costs are clearly correlated to the maximum power transmitted in the network. Advantages in maintenance too can be obtained with the aid of embodiments of the invention, for example, an exceptional increase in consumption can result in a request to inform maintenance operations.

In the following, the invention is examined with the aid of examples of embodiments according to the accompanying figures.

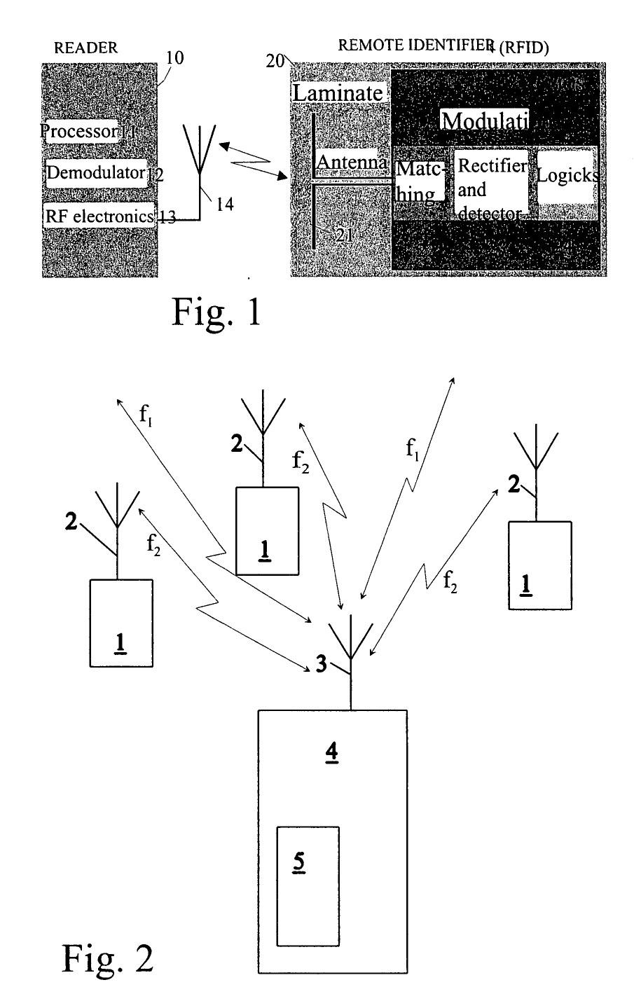

FIG. 1 shows a remote reading system according to the prior art.

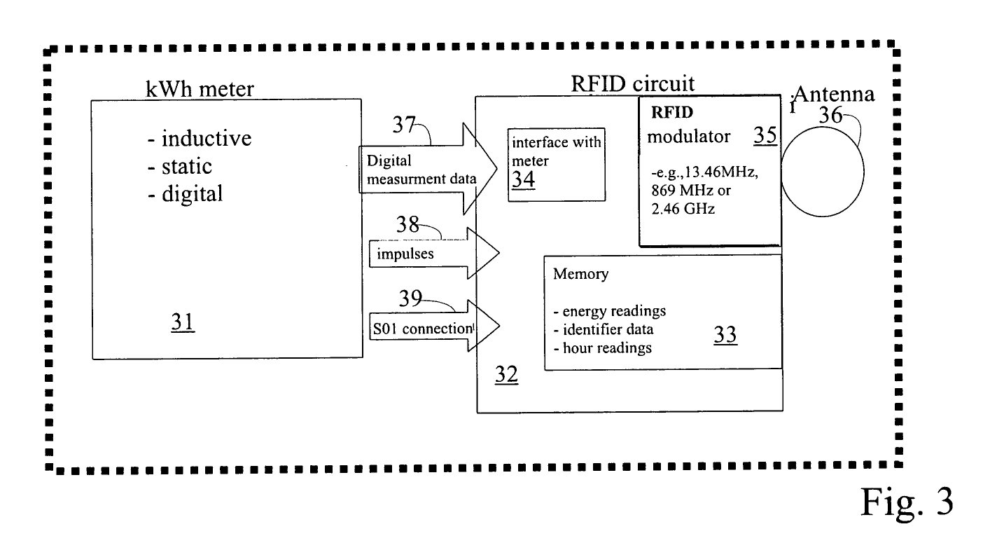

FIG. 2 shows schematically one system applying the invention.

FIG. 3 shows one system according to the invention.

The use of RFID transponders will increase in the near future. Most of them will, for example, replace optically readable bar codes in product marking. An RFID transponder is a marking that can be read remotely using a radio signal, and which comprises an antenna, a voltage-generating circuit, rf-signal modulation/demodulation circuits, and a memory. The memory can be both written and read with the aid of a radio signal. There are several different types of transponder; passive and active, as well as those connected inductively, capacitively, or with the aid of radio-frequency radiation. Passive transponders generate the electrical energy they require from the rf field directed at them. In active transponders there is a separate battery or other source of current. Inductively connected transponders typically operate at the 125-kHz or 13.56-MHz frequencies. This frequency is interesting at present, because mobile telephones will soon support this frequency. Partly for this reason, the examples relate to this frequency.

Alternative frequencies are 869 MHZ, 915 MHz (USA), and 2.45 Ghz.

An RFID transponder is a small device, comprising an antenna, a microcircuit, and a memory, which transmits the contents of its memory by backscattering once it receives the transmit command from the reading device, and the reading device has illuminated with a radio signal. In a passive transponder, there is no battery, instead it takes the operating power it requires from the radio signal sent to it by the reading device. Power and information can be transmitted between the transponder and the reading device with the aid of a magnetic field, an electrical field, or a radiating radio signal. In several embodiments of the transponder, it is important for the distance between the reading device and the transponder to be long—even up to several metres.

The present invention discloses a method, in which an RFID-standard compliant circuit, which collects the readings of the meter, is installed in a kWh meter. The circuit also contains the meter's identification information and the address to which the information should be transmitted. The contents of the circuit are transferred to a portable reading device, and from there forwarded through a mobile telephone to the power company.

By means of the method disclosed in the present invention, the display and keypad of the power-measuring apparatus can be replaced with a mobile telephone. In addition, the power measurement can be implemented using an RFID circuit, so that an entire power-measuring unit for a domestic appliance can be manufactured at a current price level of about ε 1. Naturally the same concept can be used in other devices, for instance in machines and devices used in industry.

The typical remote-reading system according to FIG. 1 comprises a reading device 10, and an RFID transponder 20, which communicate wirelessly with each other. The reader 10 typically comprises a processor 11, a demodulator 12, and RF electronics, as well as an antenna 14 for producing and receiving a radio-frequency signal. The RFID transponder 20 in turn includes an antenna 21, a matching circuit 22, a rectifier with a detector 23, and a logic circuit 24. Modulation is produced by the combined operation of the logic 24 and matching circuit 22. In this embodiment, the transponder 20 is typically formed on a normal circuit-board structure, so which operating energy is drawn from the normal electricity network. This form of implementation is used because the transponder is electrically connected to a device, such as an energy-consumption meter or domestic appliance using the normal electricity network. To facilitate its installation, the transponder 20 can also be laminated onto a thin board, often of a credit-card size, in which case the board will be equipped with quick-connect terminals to connect it to the energy-consumption meter or domestic appliance.

According to FIG. 2, a typical system according to the invention comprises RFID transponders or sensors 1, in which an antenna 2 is integrated. Each transponder I is connected to either an energy meter or alternatively to a domestic appliance that consumes electricity. In addition, the system comprises a remote reading device 5, which can be integrated in a mobile station 4. The reading device 5 typically comprises its own antenna 3. The mobile station 4 typically comprises a transmitter, a receiver, and, supporting them, electronics with software, as well as an antenna 3 for permitting mobile communications on an operating frequency f. In addition, in the mobile station there is a battery, which acts as a power supply for providing electric energy for the transmitter and receiver electronics. In addition, modern mobile stations also include a display.

In the present invention there is a method implemented according to FIG. 3, in which a circuit 32 according to the RFID standard, which collects the readings of the meter 31, is installed. The meter 31 can be inductive, static, or digital. The circuit 32 also contains the identification information of the meter 31 and an address, to which the energy-consumption information should be sent. The contents of the circuit 32 are transferred to a portable reading device 5 (FIG. 2), and from there forwarded through a mobile telephone 4 to the power company. The mobile telephone can include an RFID reading device 5, or the information can be transferred with the aid of Bluetooth from a portable reading device (not shown) to the mobile telephone 4. The information can be transferred from the telephone using GSM data, text messaging, GPRS, or some other corresponding transfer protocol. Once it receives the readings, the power company can send the consumer information on the cost of the electricity, make offers, etc. If the mobile telephone has, for example, a Bluetooth capability, the customer can, if they desire, transfer the information to their own computer or obtain the information over the internet. The essential feature when using a mobile telephone is that the return information comes immediately after the customer has read the kWh meter 31, for example, by bringing the reading device close to the kWh meter 31 and the RFID circuit 32 connected to it. This ‘reward’ will probably mean that customers will willingly perform meter reading. If necessary, the costs arising from the call can be deducted from the electricity bill.

Because power companies will benefit from the system, they can price electricity more cheaply for those customers who agree to touch the kWh meter with their mobile telephone at regular intervals. Once the content of the circuit in the meter has been read, the RFID reading device resets to zero part of the contents of the memory. The reading device can also alter the time interval of the readings. If the contents are not read, the circuit can also automatically extend the time interval, to prevent the memory from becoming full too quickly. The module 32 can also possibly contain a ‘buzzer’, the sound of which will remind the customer of the need to make a reading.

The typical assembly according to the invention according to the block diagram of FIG. 3 consists of an RFID circuit 32, which in turn comprises an interface 34 to an energy-consumption meter 31. Whenever necessary the interface 34 is made in such a way that it permits power supply and measurement data, but also other information to be transmitted. The most important feature of the interface is the impulse information 38, which is standardized information already in existing energy meters. Thus one pulse corresponds to the smallest unit of energy that can be measured, and this information is collected in the memory 33 of the RFID circuit 32, in which time information is simultaneously recorded, in other words the energy-measurement information is synchronized with a real-time clock. The time information can be used to determine the time distribution of the measured pulses and, for example, to collect information on the energy consumption during each time period. The meter's 31 identification data and possibly data on where to forward for processing the measured data are also stored in the memory 33.

The SO1 interface 39 is a standard output of the energy meter 31, from which, among other things, operating voltage for the RFID circuit 32 is obtained.

If the energy meter 31 is digital, information can be transferred to the RFID circuit 32 over a digital bus 37. In the present application, the energy meter 31 can also be interpreted as being a device that consumes energy.

In addition, the circuit 32 naturally has an RFID modulator 35, which corresponds to the element 30 with an antenna 36 shown in FIG. 1.

Because in this embodiment the RFID circuit 32 has power available to it, the circuit can be manufactured in such a way as to support all existing standards, or even in such a way that the circuit can be altered by software, to allow it to be adapted to new standards. However, the situation is now good, inasmuch as the frequencies in use have been largely fixed worldwide. Nokia, among others, has also brought onto the market a telephone that supports the 13.55-MHz standard. In 2005, several mobile-telephone manufacturers introduced an RFID reading capability in their mobile telephones. The 869-MHz frequency range will then come into use in Europe.

The circuit should be designed in such a way that, for example, if the customer does not read the information sufficiently often, readings at intervals of 1 hour become readings at intervals of 2 hours. The power company will, however, be aware of the situation and the information system can automatically activate a text message and request the customer to read their kWh meter. In addition to information on electrical power, the circuit can also transmit information on electricity quality to the power company, for example, on the number of outages or on excessive distortion of transmission energy.

### Domestic Appliances and Other Devices Consuming Energy

The energy consumption of devices can be monitored using the concept referred to above. The conditions, however, are that power measurement with 5-% inaccuracy is sufficient and the maximum power of the device is well defined. This will allow a power-measuring circuit to be integrated inside the RFID circuit. In addition, the circuit can measure quality data relating to electricity, for example, to predict a fault in the device. Other sensors (e.g., temperature) in the device can also be connected by this system to a telecommunications network through a mobile telephone, or to the consumer's mobile telephone. In the same way, instructions or a link to a telecommunications network can be transmitted, for example, to facilitate matters relating to maintenance of the device.

In domestic appliances, the device is mainly used by the consumer, who can, however, also transmit data to the network, so that the manufacturer of the domestic appliance will be able to interpret the data and send instructions concerning the condition of the device. This makes possible a service that can extend over the entire life of a domestic appliance. The same circuit can also be utilized in the recycling of a domestic appliance.

Domestic appliances that are suitable for use in connection with the invention include washing machines and refrigerating appliances, such as refrigerators and freezers.

Though GPRS technology permits remote reading even with existing meters, the technique referred to above nevertheless offers advantages in maintenance and consumption monitoring, by providing a standard interface for devices measuring power.

With the aid of embodiments of the invention, the display required under law can be moved from electricity meters to reading devices, thus creating savings in the costs of electricity meters.

In the future, the 869-MHz frequency that is being introduced will also increase the reading distance.

1. Remote detector or sensor system, which comprises
a reading device (5), which is able to transmit and receive information wirelessly by means of electromagnetic radiation, and
at least one remote detector or sensor (1, 32), which is able to communicate wirelessly with the reading device (5),
characterized in that
the remote detector or sensor (1, 32) is connected permanently to an energy-consumption measuring or an energy consuming device and is arranged to transmit energy information wirelessly to a reading device (4).

2. System according to claim 1, characterized in that the remote detector (1, 32) receives its operating energy from the device to which it is connected.

3. System according to claim 1 or 2, characterized in that the remote detector (1, 32) is connected to an energy-measuring device, such as a three-phase kilowatt-hour meter (31).

4. System according to claim 1 or 2, characterized in that the remote detector (1, 32) is connected to a domestic appliance, such as a washing machine or a refrigerator.

5. Method for a remote-detection or remote-senor system, in which method
a reading device (5) is used to transmit and receive information wirelessly by means of electromagnetic radiation, with at least one remote detector (1, 32),
characterized in that
the remote detector or remote sensor (1, 32) is connected permanently to an energy-consumption measuring or energy-consuming device (31) and is arranged to transmit energy information wirelessly to a reading device (4).

6. Method according to claim 5, characterized in that the remote detector (1, 32) is fitted in the same energy-consuming device (31), to which it is connected.

7. Method according to Claim 5 or 6, characterized in that the remote detector (1, 32) is connected to any energy-measuring device, such as a three-phase kilowatt-hour meter (31).

8. Method according to claim 5 or 6, characterized in that the remote detector (1, 32) is connected to a domestic appliance, such as a washing machine or refrigerator.

9. Use of a remote detector (1, 32) in energy-consumption measurement.

10. User according to claim 9, characterized in that the remote detector (1, 32) is used in connection with an energy-consumption meter (31).

11. Use according to claim 9, characterized in that the remote detector (1, 32) is used in connection with a domestic appliance.
